(19) United States
(12) Patent Application Publication
(10) Pub. No.: US 2012/0036524 A1
(43) Pub. Date: Feb. 9, 2012

(54) SYSTEM AND METHOD FOR SOCIAL NETWORKING USING AN INTERNET TELEVISION

(76) Inventors: SATISH MUGULAVALLI, Bangalore (IN); SRIRAM NEELAKANDAN, Bangalore (IN)

(21) Appl. No.: 13/193,628

(22) Filed: Jul. 29, 2011

Related U.S. Application Data
(60) Provisional application No. 61/370,111, filed on Aug. 3, 2010.

(51) Int. Cl. H04N 21/458; H04N 21/84; H04N 21/24; H04N 21/6377

(52) U.S. Cl. 725/9; 725/110; 725/25; 725/46

(57) ABSTRACT

A system and method for social networking using an Internet television (TV) associated with an Internet TV set-top box are disclosed. In one embodiment, a user is allowed to register in a social network by creating a user profile using the Internet TV set-top box by a content sharing platform. Further, the user profile of the registered user is stored in a profile database by the content sharing platform. Furthermore, the user profile of the registered user is connected with user profiles of other users based on registered user's preferences by the content sharing platform. In addition, the registered user is allowed to organize and store content into different categories based on the registered user's preferences via the Internet TV set-top box by the content sharing platform. Also, the registered user and the other users are allowed to view the organized content by the content sharing platform.

This application claims priority under 35 U.S.C 119(e) to U.S. Provisional Application No. 61/370,111 entitled “System and method for social networking using internet television” by Satish Mugulavalli et al. filed on Aug. 3, 2010, which is incorporated herein by reference.

### BACKGROUND

Internet television (TV) has changed the face of media broadcast in recent years. Internet technology has made possible presentation of unlimited multi-media content across the world by the Internet TV. Viewers are no longer confined to watching programs broadcasted by service providers. Moreover, the viewers themselves may become content providers on the Internet. For example, viewers of an Internet media repository, such as YouTube®, have the ability to upload video content and view an array of other video content on the Internet.

However, even with the advancement of the Internet TV, because of the voluminous video content presented on the Internet, locating desired video content can be as difficult as finding a needle in a haystack. For example, National Geographic® has placed several wild life videos on the Internet. Due to excellent photography and rich video content, nature/animal lovers may find these videos extremely enticing and fascinating. However, without a means for sharing these videos, each viewer, who is interested in watching these videos, may have to start from scratch while locating these videos.

One way to avoid such duplicate efforts by the viewers in locating the desired media of interest is sharing the available video content with others. Growing popularity of the online social networks, such as My Space®, FriendWise®, Friend Finder®, Yahoo! 360®, Facebook®, Orkut®, Classmates®, YouTube® and LinkedIn® indicate the growing importance of social networking as an important tool for gathering individuals sharing common interests. Online social networking may be implemented through websites. Typically, community members of the online communities may be granted an access to the contact information of the other community members. Generally, members of the social network may discuss issues and exchange information pertaining to their common areas of interests, such as movies, sports, arts and the like. Instead of each member searching for certain video content, it will be beneficial if only one member searches for a video content and shares the video content with the other members of the online community.

In spite of the advancement of the Internet TV, at present, online community members may have to rely on conventional means for sharing their favorite video content with their other members. For example, if a viewer of an existing Internet TV happens to be a member of an online community and wishes to share a TV program or video content with other members, the viewer may have to record the TV program and send it to the other members. Alternatively, the viewer may have to inform a friend to watch a live TV program being relayed by a service provider.

### BRIEF DESCRIPTION OF THE DRAWINGS

Various embodiments are described herein with reference to the drawings, wherein:

FIG. 1 illustrates a system for social networking using an Internet television (TV) set-top box, according to one embodiment;

FIG. 2A illustrates a flowchart of a method of enabling a user to register, organize content and view the organized content via the Internet TV set-top box in a social network, according to one embodiment;

FIG. 2B illustrates another flowchart of a method of logging into the social network by a user using login credentials associated with other existing social networks via the Internet TV set-top box, according to one embodiment;

FIG. 3 illustrates yet another flowchart of a method of sharing the organized content by the user in the social network, according to one embodiment;

FIG. 4 illustrates a flowchart of a method of sharing the organized contents by the user in the social network, according to one embodiment;

FIG. 5 illustrates another flowchart of a method of sharing the organized contents by the user in the social network, according to one embodiment; and

FIG. 6 is a block diagram illustrating the social network, such as the one shown in FIG. 1, including various system elements, according to one embodiment.

The drawings described herein are for illustration purposes only and are not intended to limit the scope of the present disclosure in any way.

### DETAILED DESCRIPTION

A system and method for social networking using an Internet television (TV) are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

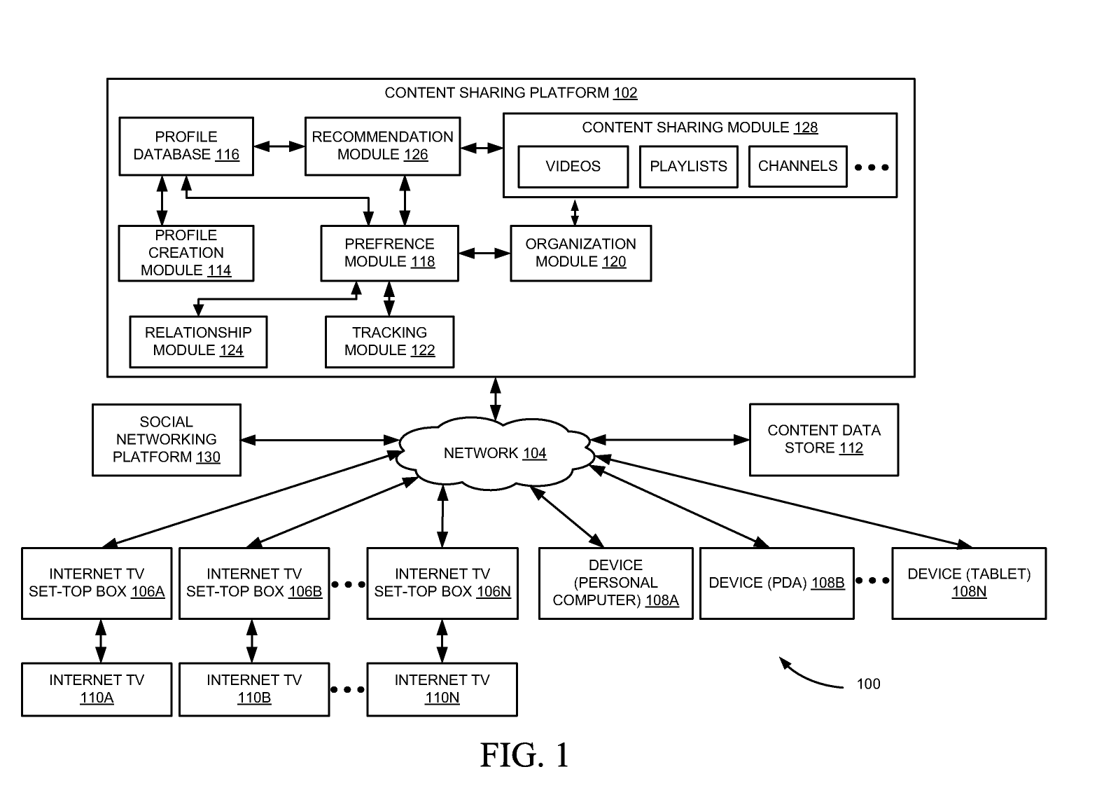

FIG. 1 illustrates a system for social networking using an Internet TV set-top box, according to one embodiment. Particularly, FIG. 1 illustrates a social network 100 including a content sharing platform 102, one or more Internet TV set-top boxes 106A-N, one or more devices 108A-N, a social networking platform 130 and a content data store 112. Exemplary devices include a personal computer (PC), a personal digital assistant (PDA), a laptop, a tablet and the like. Further as shown in FIG. 1, the content sharing platform 102 is coupled to the Internet TV set-top boxes 106A-N, the devices 108A-N, the social networking platform 130 and the content data store 112 via a network 104. Exemplary network includes a local area network (LAN), a wide area network (WAN), a Wi-Fi and the like. Furthermore as shown in the FIG. 1, each of the Internet TV set-top boxes 106A-N is coupled to an associated one of Internet TVs 110A-N.

In one embodiment, the content sharing platform 102 includes a profile creation module 114, a profile database 116, a preference module 118, an organization module 120, a tracking module 122, a relationship module 124, a recommendation module 126 and a content sharing module 128. As shown in FIG. 1, the profile creation module 114 is coupled to the profile database 116. Further as shown in FIG. 1, the profile database 116 is coupled to the recommendation module 126 and the preference module 118. Furthermore as shown in FIG. 1, the recommendation module 126 is coupled to the content sharing module 128 and the preference module 118. In addition as shown in FIG. 1, the preference module 118 is coupled to the relationship module 124, the tracking module 122 and the organization module 120.

In operation, a user registers in the social network 100 using an associated one of the Internet TV set-top boxes 106A-N. Exemplary user includes an individual user, a user associated with a group, a user associated with an association or a user associated with the social network 100. In one embodiment, the profile creation module 114 in the content sharing platform 102 allows the user to register in the social network 100 by creating a user profile via the associated one of the Internet TV set-top boxes 106A-N. The user creates the user profile by providing user information, such as a name, an email ID, an address, a telephone number, a unique identifier associated with the Internet TV set-top box, age, a list of user's preferences and the like. Exemplary user's preferences include user location, time/frequency of watching a content, user connections and content meta-data, such as an author, a director, a studio, a genre, an actor, a language and the like.

Further in operation, the content sharing platform 102 stores the user profile of the registered user in the profile database 116. The profile database 116 is a repository for storing user profiles associated with the registered users of the Internet TV set-top boxes 106A-N. In an exemplary embodiment, when a registered user updates the profile, the profile database 116 updates the associated user profile as updated by the registered user. Furthermore in operation, the list of user's preferences associated with each of the registered users is stored in the preference module 118. In addition in operation, the relationship module 124 in the content sharing platform 102 connects the user profile of the registered user with user profiles of other users based on the registered user's preferences.

In another embodiment, the content sharing platform 102 allows a user to login into the social network 100 using login credentials associated with other existing social networks via an associated one of the Internet TV set-top boxes 106A-N. Exemplary other existing social networks include My Space®, FriendWise®, FriendFinder®, Yahoo! 360®, Facebook®, Orkut®, Classmates®, YouTube®, LinkedIn® and the like. Further, the content sharing platform 102 obtains user's preferences and other users associated with the user from the other existing social networks. Furthermore, the content sharing platform 102 transfers the obtained user's preferences and associations with the other users to the social network 100. In this embodiment, the obtained user's associations with the other users are stored in the social networking platform 130.

Hereinafter, in the description of FIG. 1, the term user refers to the users registered in the social network 100 and the users logging into the social network 100 using the login credentials associated with the other existing social networks.

In addition in operation, the organization module 120 allows the user to organize content in the content data store 112 into different categories based on the user's preferences using the associated one of the Internet TV set-top boxes 106A-N. Exemplary categories include playlists, channels, videos, electronic program guide (EPG), favorites, menus and the like. In this embodiment, the content data store 112 includes content and/or links to the content created by the user and content created by content providers, service providers and so on. Exemplary content includes multi-media content, audio content, video content, photos and the like. For example, if the user's preference is baseball, then the user can organize the content associated with baseball in the content data store 112. If a channel or video is preferred by the user, it may be classified as favorites. In some embodiments, the user may organize the content in the content data store 112 using a menu on a display of the associated one of the Internet TVs 110A-N and a remote control device. For example, the user may organize the content in the content data store 112 by creating a new playlist, adding content to the playlist, removing content from the playlist, creating channels, adding channels to existing categories, creating EPG, adding channels to the existing EPG and the like.

Also in operation, the tracking module 122 tracks the content that is being organized by the users. Moreover in operation, the content sharing platform 102 allows the user to store the organized content using the associated one of the Internet TV set-top boxes 106A-N. In this embodiment, the content sharing platform 102 stores the organized content in the content sharing module 128. As shown in FIG. 1, the content sharing module 128 includes videos, playlists, channels and so on organized by the user. In addition in operation, the content sharing platform 102 allows the user and the other users connected to the user to view the organized content.

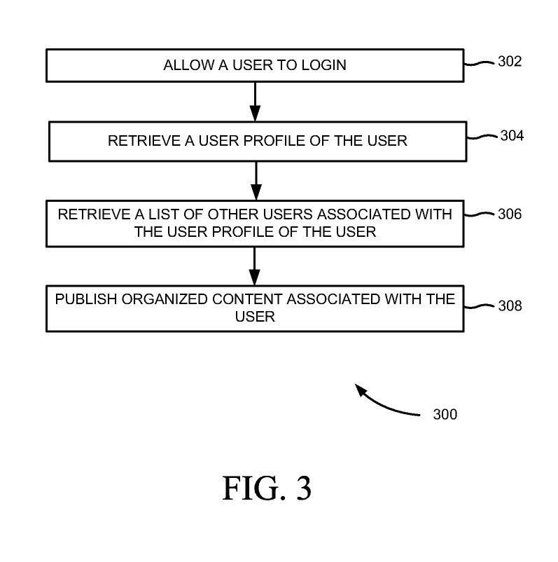

In one embodiment, the organized content associated with the user is shared with the others users connected to the user by publishing the organized content on the associated one of the Internet TVs 110A-N associated with each of the other users. This is explained in more detail with reference to FIG. 3.

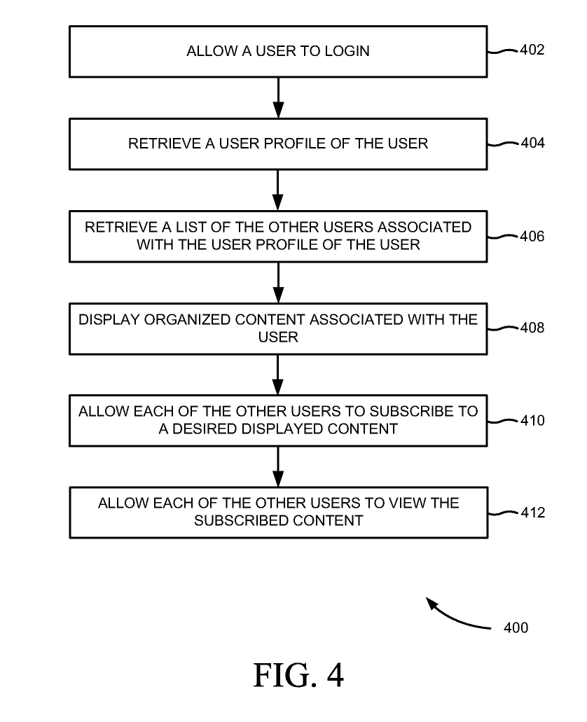

In another embodiment, the organized content associated with the user is shared with the others users connected to the user by displaying the organized content based on a category specified by each of the other users on the associated one of the Internet TVs 110A-N. Further in this embodiment, the content sharing platform 102 allows the each of the other users to subscribe to a desired content displayed on the associated one of the Internet TVs 110A-N. Furthermore, the content sharing platform 102 allows the each of the other users to view the subscribed content on the associated one of the Internet TVs 110A-N. This is explained in more detail with reference to FIG. 4.

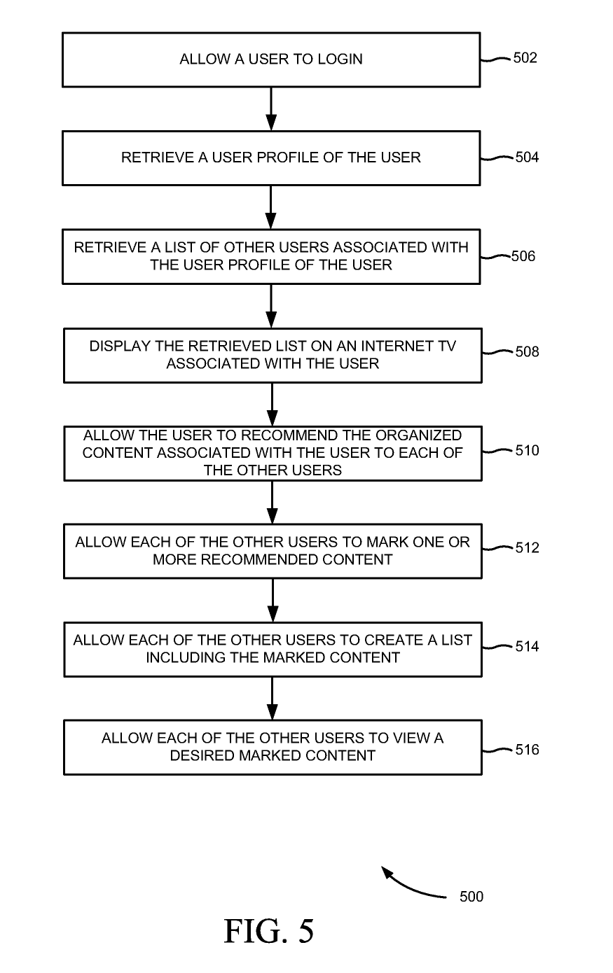

In yet another embodiment, the organized content associated with the user is shared with the others users connected to the user by recommending the organized content to the others users connected to the user. In this embodiment, the recommendation module 126 recommends the organized content associated with the user to the other users associated with the user. Further, the content sharing platform 102 allows the each of the other users to mark one or more recommended content. Furthermore, the content sharing platform 102 allows the each of the other users to create a list including the marked content. In addition, the content sharing platform 102 allows the each of the other users to view a desired marked content from the created list on the associated one of the Internet TVs 110A-N. This is explained in more detail with reference to FIG. 5.

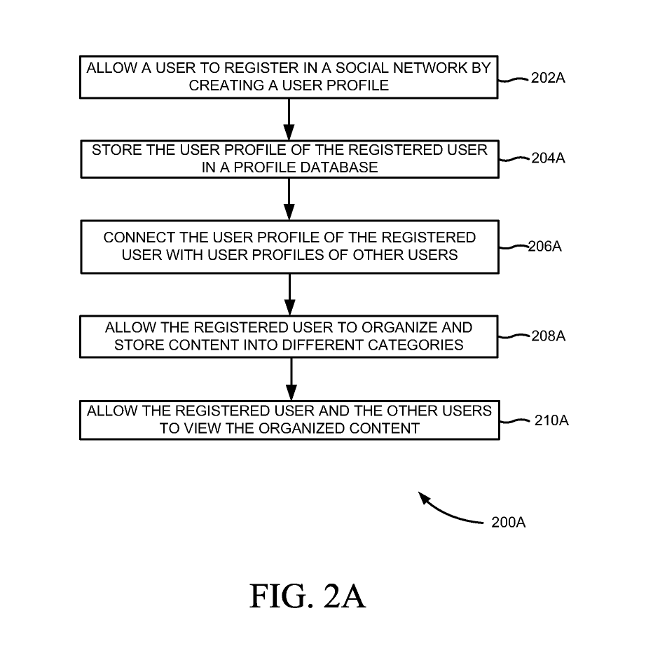

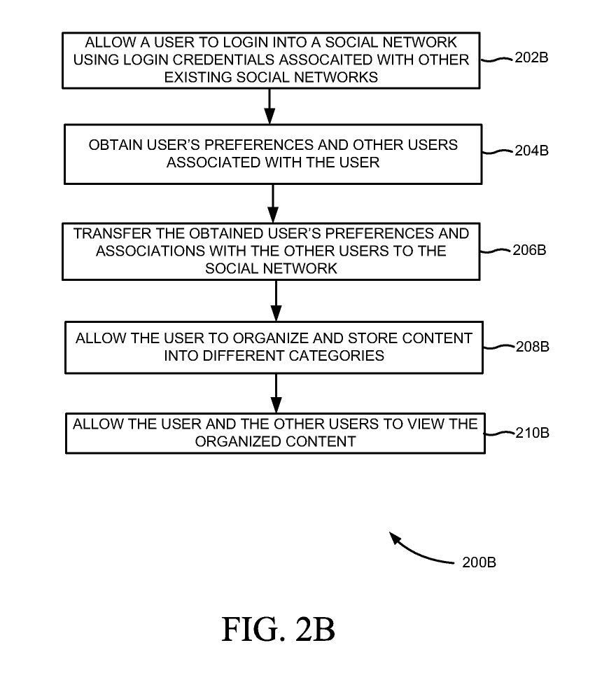

Referring now to FIG. 2A, a flowchart 200A illustrates a method of enabling users to register, organize content and view the organized content via an Internet TV set-top box in a social network, according to one embodiment. Exemplary users include an individual user, a user associated with a group, a user associated with an association, a user associated with the social network and the like. At block 202A, the user is allowed to register in the social network by creating a user profile via the Internet TV set-top box by a content sharing platform. Exemplary user profile includes user information, such as a name, an email ID, an address, a telephone number, a unique identifier associated with an Internet TV set-top box, user's preference, age and the like.

At block 204A, the user profile of the registered user is stored in a profile database associated with the social network by the content sharing platform. At block 206A, the user profile of the registered user is connected with user profiles of other users based on registered user's preferences by the content sharing platform. Exemplary user's preferences include a user location, time/frequency of watching content, user connections and content meta-data, such as an author, a director, a studio, a genre, an actor, a language and the like. At block 208A, the registered user is allowed to organize and store content into different categories based on the registered user's preferences via the Internet TV set-top box by the content sharing platform. Exemplary content includes multi-media content, audio content, video content, photos and the like. Exemplary categories include playlists, channels, videos, electronic program guide (EPG), favorites, menus and the like. At block 210A, the registered user and the other users are allowed to view the organized content by the content sharing platform.

Referring now to FIG. 2B, another flowchart 200B illustrates a method of logging into a social network by a user using login credentials associated with other existing social networks via an Internet TV set-top box, according to one embodiment. Exemplary users include an individual user, a user associated with a group, a user associated with an association, a user associated with the existing social networks and the like. At block 202B, the user is allowed to login into the social network using the login credentials associated with the other existing social networks via the Internet TV set-top box by a content sharing platform. At block 204B, user's preferences and other users associated with the user are obtained from the other existing social networks by the content sharing platform. At block 206B, the obtained user's preferences and associations with the other users are transferred to the social network by the content sharing platform. At block 208B, the user is allowed to organize and store content into different categories based on the user's preferences via the Internet TV set-top box by the content sharing platform. At block 210B, the user and the other users are allowed to view the organized content on the associated Internet TV by the content sharing platform.

Referring now to FIG. 3, yet another flowchart 300 illustrates a method of sharing organized content by users in a social network, according to one embodiment. In block 302, the user is allowed to login into the social network by a content sharing platform. For example, the user includes a user registered in the social network or the user associated with other existing social networks. In block 304, a user profile associated with the user is retrieved by the content sharing platform. In one embodiment, the user profile associated with the user is retrieved from a profile database associated with the social network. In another embodiment, the user profile associated with the user is retrieved from the other existing social networks. In block 306, a list of other users associated with the user profile of the user is retrieved by the content sharing platform. In one embodiment, the list of other users associated with the user profile is retrieved from the profile database associated with the social network. In another embodiment, the list of other users associated with the user profile is retrieved from the other existing social networks. In block 308, organized content associated with the user is published on the Internet TV associated with each of the other users in the retrieved list by the content sharing platform. Further, organizing the content by the content sharing platform is explained in more detail with reference to FIG. 1.

Referring now to FIG. 4, a flowchart 400 illustrates a method of sharing organized content by users in a social network, according to one embodiment. In block 402, the user is allowed to login into the social network by a content sharing platform. For example, the user includes a user associated with the social network or the user associated with other existing social networks. In block 404, a user profile associated with the user is retrieved by the content sharing platform. In one embodiment, the user profile associated with the user is retrieved from a profile database associated with the social network. In another embodiment, the user profile associated with the user is retrieved from the other existing social networks. In block 406, a list of the other users associated with the user profile of the user is retrieved by the content sharing platform. In one embodiment, the list of other users associated with the user profile is retrieved from the profile database associated with the social network. In another embodiment, the list of other users associated with the user profile is retrieved from the other existing social networks.

In block 408, the organized content associated with the user is displayed based on a category specified by each of the other users in the retrieved list on the Internet TV associated with each of the other users by the content sharing platform. Further, organizing the content by the content sharing platform is explained in more detail with reference to FIG. 1. In block 410, the each of the other users is allowed to subscribe to a desired displayed content by the content sharing platform. In block 412, the each of the other users is allowed to view the subscribed content on the associated Internet TV by the content sharing platform.

Referring now to FIG. 5, another flowchart 500 illustrates a method of sharing organized content by users in a social network, according to one embodiment. In block 502, the user is allowed to login into the social network by a content sharing platform. For example, the user includes a user associated with the social network or the user associated with other existing social networks. In block 504, a user profile associated with the user is retrieved by the content sharing platform. In one embodiment, the user profile associated with the user is retrieved from a profile database associated with the social network. In another embodiment, the user profile associated with the user is retrieved from the other existing social networks. In block 506, a list of the other users associated with the user profile of the user is retrieved by the content sharing platform. In one embodiment, the list of other users associated with the user profile is retrieved from the profile database associated with the social network. In another embodiment, the list of other users associated with the user profile is retrieved from the other existing social networks.

In block 508, the retrieved list is displayed in the Internet TV associated with the user by the content sharing platform. In block 510, the user is allowed to recommend the organized content associated with the user to each of the other users in the displayed list by the content sharing platform. Further, organizing the content by the content sharing platform is explained in more detail with reference to FIG. 1. In block 512, the each of the other users is allowed to mark one or more recommended content by the content sharing platform. In block 514, the each of the other users is allowed to create a list including the marked content by the content sharing platform. In block 516, the each of the other users is allowed to view a desired marked content from the created list on the Internet TV by the content sharing platform.

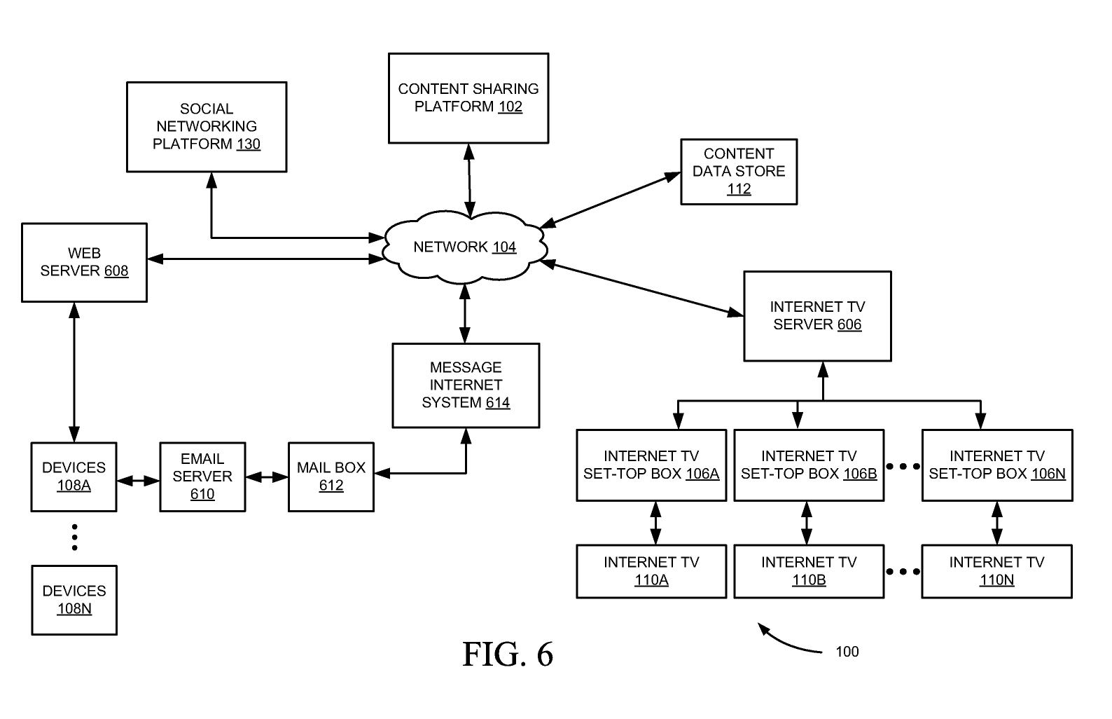

Referring now to FIG. 6, a block diagram illustrates the social network 100, such as the one shown in FIG. 1, including various system elements, according to one embodiment. As shown in FIG. 6, the social network 100 includes the content sharing platform 102, the social networking platform 130, the content data store 112, a web server 608, a message Internet system 614, an email server 610, a mail box 612, an Internet TV server 606, the one or more devices 108A-N, the one or more Internet TV set-top boxes 106A-N and the one or more Internet TVs 110A-N. Further as shown, the content sharing platform 102, the social networking platform 130, the content data store 112, the web server 608, the message Internet system 614 and the Internet TV server 606 are coupled to the network 104.

Furthermore as shown, the each of the Internet TVs 110A-N is coupled to an associated one of the Internet TV set-top boxes 106A-N. In addition as shown, the Internet TV set-top boxes 106A-N are coupled to the network 104 via the Internet TV server 606. Also as shown, the devices 108A-N are coupled to the network 104 either via the web server 608 or the message Internet systems 614.

Hereinafter, in the description of FIG. 6, the term user refers to the users registered in the social network 100 and the users logging into the social network 100 using the login credentials associated with other existing social networks. This is explained in more detail with reference to FIG. 1.

In one exemplary operation, a user of the Internet TV set-top box 106A sends a login request via the Internet TV server 606 to access one or more services provided by the content sharing platform 102. If the user is a registered user and login details provided by the user are correct, then the content sharing platform 102 authenticates the user and allows the user to communicate with the content sharing platform 102 to avail the one or more services. It can be noted that, the user is socially connected to one or more other users via the social networking platform 130. Thus, the content sharing platform 102 enables the user to be socially connected with the other users of the Internet TVs 110B-N.

The social networking platform 130 maintains a social graph depicting the interrelationships between the users in the social network 100. Formation of a network of friends is well known in the art. Typically, a user's friends list contains a set of other users associated with the user's address book, buddies list, etc. Alternatively, a friends list can also be formed by the user by presenting an explicit request to another user to join the user's friends list. In particular, the social graph depicts the interrelationships between various users in the social network 100. In one embodiment, the social networking platform 130 maintains the social graph depicting the interrelationships between users of the social network 100 and/or relationship between groups of the social network 100 in a graphical form, such as a graph, a tree, a list or any other data structure. Further, the social networking platform 130 designates unique IDs for each user in the social network 100 and stores the friends list and the user's preference list associated with each user in the social network 100. Furthermore, the social networking platform 130 promptly monitors or can be readily configured to promptly monitor even minor changes occurring in the social graphs.

In one embodiment, upon successful authentication, the user may search for the content (e.g., video content, photos, music, channels, etc.) on the Internet via the associated Internet TV set-top box 106A and organize the content into different categories based on the user's preference. This is explained in more detail with reference to FIG. 1.

In another embodiment, the user may publish the organized content using the content sharing platform 102, such that the organized content is made available to the other users, such as Internet TV users, PC users and the like who are socially connected to the user. For example, the organized content associated with the user of the Internet TV 110A is displayed to the other users on an associated one of the Internet TVs 110B-N. In some embodiments, the other users may subscribe to the published content in order to view the content if the preference of the other users is same as the user's preference. For example, if the other user is a user of the Internet TV set-top box 106B, then the user may view the subscribed content on the associated Internet TV 110B. If the other user is a user of a device, say, device 108A connected to the content sharing platform 102 via Internet, then the other user may access the published content via the email server 610 or the web server 608.

The devices 108A-N may include without limitation a PC, a laptop, a cellular communication device, a single-processor or multiprocessor computer system, a minicomputer, a mainframe computer, as well as a hand-held computing device, microprocessor-based or programmable consumer electronic and the like. Exemplary email server 610 includes any communication server that may be configured to enable communication between networked devices, such as simple mail transfer protocol (SMTP) servers, short message peer-to-peer protocol (SMPP) servers, short messaging service (SMS) servers, various text messaging servers, voice over internet protocol (VoIP) servers, instant messenger (IM) servers, multi-media messaging service (MMS) servers, RSS servers, and the like. The email server 610 employs a database, a file structure and the like to store the received emails.

In yet another embodiment, a list of the organized content associated with the user of the Internet TV 110A is displayed to the other users who are not directly connected to the user. In other words, the content sharing platform 102 recommends the list of the organized content to the other users not directly linked or connected to the user of the Internet TV set-top box 106A. If the preferences and likes of any of the other users are same as the user, then the content sharing platform 102 enables the other users to get socially connected with the user of the Internet TV set-top box 106A so that the other users can subscribe to the organized content and view the subscribed content on the associated one of the Internet TVs 110B-N.

In a further embodiment, the user of the Internet TV set-top box 106A may be provided with a list of contents organized by the other users of the Internet TV set-top boxes 106B-N. Based on the recommendation, the user of the Internet TV set-top box 106A may mark the content and view the marked content on the associated Internet TV set-top box 106A.

One skilled in the art will appreciate that, the one or more modules of the content sharing platform 102 shown in FIG. 1 may enable the social network 100 shown in FIG. 6 to perform one or more operations described above.

In various embodiments, system and method described in FIGS. 1 through 6 propose the social networking using the Internet TV. Further, the system and method for social networking allow the user of the Internet TV in the social network to share the content associated with the user to the other users in the social network without recording or downloading the content.

A skilled person will recognize that many suitable designs of the systems and processes may be substituted for or used in addition to the configurations described above. It should be understood that the implementation of other variations and modifications of the embodiments of the invention and its various aspects will be apparent to one ordinarily skilled in the art, and that the invention is not limited by the exemplary embodiments described herein. Therefore, it is contemplated to cover the present embodiments of the invention and any and all modifications, variations, or equivalents that fall within the true spirit and scope of the basic underlying principles disclosed herein. The contents of all references cited are incorporated herein by reference in their entireties.

What is claimed is:

1. A method for social networking using an Internet Television (TV), comprising:
allowing a user to register in a social network by creating a user profile using an Internet TV set-top box by a content sharing platform;
storing the user profile of the registered user in a profile database by the content sharing platform;
connecting the user profile of the registered user with user profiles of other users based on registered user's preferences by the content sharing platform;
allowing the registered user to organize and store content into different categories based on the registered user's preferences via the Internet TV set-top box by the content sharing platform; and
allowing the registered user and the other users to view the organized content by the content sharing platform.

2. The method of claim 1, further comprising:
allowing the registered user to login into the social network by the content sharing platform;
retrieving the user profile of the registered user from the profile database by the content sharing platform;
retrieving a list of other users associated with the user profile of the registered user from the profile database by the content sharing platform; and
publishing the organized content associated with the registered user on the Internet TV associated with each of the other users in the retrieved list by the content sharing platform.

3. The method of claim 1, further comprising:
allowing the registered user to login into the social network by the content sharing platform;
retrieving the user profile of the registered user from the profile database by the content sharing platform;
retrieving the list of other users associated with the user profile of the registered user from the profile database by the content sharing platform;
displaying the organized content associated with the registered user based on a category specified by each of the other users in the retrieved list on the Internet TV associated with each of the other users by the content sharing platform;
allowing each of the other users to subscribe to a desired displayed content by the content sharing platform; and
allowing each of the other users to view the subscribed content on the associated Internet TV by the content sharing platform.

4. The method of claim 1, further comprising:
allowing the registered user to login into the social network by the content sharing platform;
retrieving the user profile of the registered user from the profile database by the content sharing platform;
retrieving the list of other users associated with the user profile of the registered user from the profile database by the content sharing platform;
displaying the retrieved list on the Internet TV associated with the registered user by the content sharing platform;
allowing the registered user to recommend the organized content associated with the registered user to each of the other users in the displayed list by the content sharing platform;
allowing each of the other users to mark one or more recommended content by the content sharing platform;
allowing each of the other users to create a list including the marked content by the content sharing platform; and
allowing each of the other users to view a desired marked content from the created list on the Internet TV by the content sharing platform.

5. The method of claim 1, wherein the user comprises an individual user, a user associated with a group, a user associated with an association or a user associated with the social network.

6. The method of claim 1, wherein the user profile comprises user information selected from the group consisting of a name, an email ID, an address, a telephone number, a unique identifier associated with the Internet TV set-top box, a list of user's preferences and age.

7. The method of claim 1, wherein the content comprises multi-media content, audio content, video content and photos.

8. The method of claim 1, wherein the categories comprise playlists, channels, videos, electronic program guide (EPG), favorites and menus.

9. The method of claim 1, wherein the user's preferences comprise user location, time/frequency of watching a content, user connections and content meta-data.

10. A method for social networking using an Internet Television (TV), comprising:
allowing a user to login into a social network using login credentials associated with other existing social networks via an Internet TV set-top box by a content sharing platform;
obtaining user's preferences and other users associated with the user from the other existing social networks by the content sharing platform;
transferring the obtained user's preferences and associations with the other users to the social network by the content sharing platform;
allowing the user to organize and store content into different categories based on the user's preferences via the Internet TV set-top box by the content sharing platform; and
allowing the user and the other users to view the organized content by the content sharing platform.

11. The method of claim 10, further comprising:
retrieving the user profile associated with the user from the other existing social networks by the content sharing platform;
retrieving a list of other users associated with the user profile associated with the user from the other existing social networks by the content sharing platform; and
publishing the organized content associated with the user on the Internet TV associated with each of the other users in the retrieved list by the content sharing platform.

12. The method of claim 10, further comprising:
retrieving the user profile associated with the user from the other existing social networks by the content sharing platform;
retrieving the list of other users associated with the user profile associated with the user from the other existing social networks by the content sharing platform;
displaying the organized content associated with the user based on a category specified by each of the other users in the retrieved list on the Internet TV associated with each of the other users by the content sharing platform;
allowing each of the other users to subscribe to a desired displayed content by the content sharing platform; and
allowing each of the other users to view the subscribed content on the associated Internet TV by the content sharing platform.

13. The method of claim 10, further comprising:
retrieving the user profile associated with the user from the other existing social networks by the content sharing platform;
retrieving the list of other users associated with the user profile associated with the user from the other existing social networks by the content sharing platform;
allowing the user to recommend the organized content associated with the user to each of the other users in the displayed list by the content sharing platform;
allowing each of the other users to mark one or more recommended content by the content sharing platform;
allowing each of the other users to create a list including the marked content by the content sharing platform; and
allowing each of the other users to view a desired marked content from the created list on the Internet TV by the content sharing platform.

14. The method of claim 10, wherein the user comprises an individual user, a user associated with a group, a user associated with an association or a user associated with the other existing social networks.

15. The method of claim 10, wherein the user profile comprises user information selected from the group consisting of a name, an email ID, an address, a telephone number, a unique identifier associated with the Internet TV set-top box, a list of user's preferences and age.

16. The method of claim 10, wherein the content comprises multi-media content, audio content, video content and photos.

17. The method of claim 10, wherein the categories comprise playlists, channels, videos, electronic program guide (EPG), favorites and menus.

18. The method of claim 10, wherein the user's preferences comprise user location, time/frequency of watching a content, user connections and content meta-data.

19. A system for social networking using an Internet Television (TV), comprising:
one or more Internet TV set-top boxes, wherein each of the one or more Internet TV set-top boxes is coupled to an associated one of one or more Internet TVs;
one or more devices; and
a content sharing platform coupled to the one or more Internet TVs and the one or more devices via the network, comprises:
a profile creation module;
a profile database coupled to the profile creation module;
an organization module;
a content sharing module coupled to the organization module; and
a relationship module; wherein the profile creation module allows a user to register in a social network by creating a user profile using an associated one of the one or more Internet TV set-top boxes, wherein the content sharing platform stores the user profile of the registered user in the profile database, wherein the relationship module connects the user profile of the registered user with user profiles of other users based on registered user's preferences, wherein the organization module allows the registered user to organize content into different categories based on the registered user's preferences using the associated one of the one or more Internet TV set-top boxes, wherein the content sharing module allows the registered user to store the organized content using the associated one of the one or more Internet TV set-top boxes; and wherein the content sharing platform allows the registered user and the other users to view the organized content.

20. The system of claim 19, wherein the content sharing platform further comprises:
a recommendation module coupled to the content sharing module and the profile database, wherein the recommendation module allows the registered user to recommend the organized content to the other users.

21. The system of claim 19, wherein the content sharing platform further comprises:
a preference module coupled to the profile database, the recommendation module, the relationship module and the organization module, wherein the preference module stores a list of user's preferences associated with the registered user.

22. The system of claim 19, wherein the content sharing platform further comprises:
a tracking module coupled to the preference module, wherein the tracking module tracks the content organized by the registered user.

23. The system of claim 19, further comprising:
a content data store coupled the content sharing platform, the one or more Internet TV set-top boxes and the one or more devices via the network, wherein the content data store stores the content and/or links to the content; and
a social networking platform coupled the content sharing platform, the one or more Internet TV set-top boxes, the one or more devices and the content data store via the network, wherein the social networking platform maintains a social graph depicting the interrelationships between the users in the social network

24. The system of claim 19, wherein the network comprises a local area network (LAN), a wide area network (WAN) and a Wi-Fi.

25. The system of claim 19, wherein the user comprises an individual user, a user associated with a group, a user associated with an association, a user associated with the other existing social networks or the user associated with the social network.

26. The system of claim 19, wherein the user profile comprises user information selected from the group consisting of a name, an email ID, an address, a telephone number, a unique identifier associated with the Internet TV set-top box, a list of user's preferences and age.

27. The system of claim 19, wherein the content comprises multi-media content, audio content, video content and photos.

28. The system of claim 19, wherein the categories comprise playlists, channels, videos, electronic program guide (EPG), favorites and menus.

29. The system of claim 19, wherein the user's preferences comprise of user location, time/frequency of watching a content, user connections and content meta-data.
